(19) United States
(12) Patent Application Publication
(10) Pub. No.: US 2009/0097056 A1
(43) Pub. Date: Apr. 16, 2009

(54) IMAGE FORMING METHOD AND IMAGE FORMING APPARATUS

(75) Inventors: Haeng-nan KIM, Suwon-si (KR); Woo-yeal Song, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co.,Ltd., Suwon-si (KR)

(21) Appl. No.: 12/206,960

(22) Filed: Sep. 9, 2008

(30) Foreign Application Priority Data
Oct. 10, 2007 (KR) 2007-102176

(51) Int. Cl. G06F 3/12

(52) U.S. Cl. 358/1.15

(57) ABSTRACT

An image forming method to be used with an image forming apparatus includes receiving a command to perform a direct printing operation with respect to a document; determining whether a direct printing standard, which is used to perform the direct printing operation with respect to the document, is satisfied, and displaying a message enabling a user to select whether to perform the direct printing operation if the direct printing standard is not satisfied.

### CROSS-REFERENCE TO RELATED APPLICATION

This application claims the benefit of Korean Application No. 2007-102176, filed Oct. 10, 2007, in the Korean Intellectual Property Office, the disclosure of which is incorporated herein by reference.

### BACKGROUND OF THE INVENTION

1. Field of the Invention

Aspects of the present invention relate to an image forming method and an image forming apparatus, and more particularly, to an image forming method to perform a direct printing operation, instead of performing a printing operation by using a printer driver of a host apparatus, and an image forming apparatus to perform a method thereof.

2. Description of the Related Art

An image forming apparatus forms an image on a recording medium based on printing data. More specifically, the image forming apparatus forms an image by using a printer driver stored in a host apparatus, or directly forms an image with printing data instead of using the printer driver.

The latter method, i.e., the direct printing method, includes an operation of transmitting unprocessed printing data to the image forming apparatus. The direct printing method provides a fast transmission rate as it does not require a driver. Thus, the direct printing method has been widely used.

However, an image forming apparatus should have various resources stored therein, such as an interpreter, a filter and font information, to accurately perform the direct printing. If the image forming apparatus does not have the necessary resources to perform the direct printing, a desired quality of an image may not be provided.

If a user prints a PDF (portable document file) document and if version information of the PDF document is newer than that of the interpreter of the image forming apparatus, the conventional image forming apparatus prints a dummy page or performs a data flush, thereby failing to form the image properly.

### SUMMARY OF THE INVENTION

Accordingly, an aspect of the present invention provides an image forming method which informs a user of when printing standards are not satisfied to thereby maintain an image quality if an image forming apparatus does not satisfy the standards required to perform a direct printing operation, and an image forming apparatus to perform a method thereof.

Also, another aspect of the present invention provides an image forming method which prevents unnecessary use of a recording medium and toner, and an image forming apparatus to perform a method thereof.

Further, another aspect of the present invention provides an image forming method which allows a user to select a host apparatus to process an image before a printing operation instead of having an image forming apparatus perform a direct printing operation if an image forming apparatus does not satisfy standards required to perform the direct printing operation, and an image forming apparatus to perform the method thereof.

Further, another aspect of the present invention provides an image forming method which automatically installs a printer driver if a host apparatus does not have a printer driver therein, and an image forming apparatus to perform a method thereof.

The foregoing and/or other aspects of the present invention are achieved by providing an image forming method of an image forming apparatus, the image forming method including receiving a command to perform a direct printing operation with respect to a document, determining whether a direct printing standard, which is used to perform the direct printing operation with respect to the document, is satisfied, and displaying a message enabling a user to select whether to perform the direct printing operation if it is determined that the direct printing standard is not satisfied.

According to an aspect of the present invention, the determining of whether the direct printing standard is satisfied may comprise determining whether at least one of a document interpreter, a filter and a font resource is provided in the image forming apparatus or determining whether version information of the document corresponds to an image format version of the image forming apparatus.

According to an aspect of the present invention, the image forming method further includes downloading whichever of the at least one of the interpreter, the filter and the font resource are determined not to be provided in the image forming apparatus.

According to an aspect of the present invention, the image forming method includes updating the image format version of the image forming apparatus to print the document if it is determined that the version information of the document does not correspond to the image format version of the image forming apparatus.

According to an aspect of the present invention, the displaying of the message enabling the user to select whether to perform the direct printing operation includes displaying an option enabling the user to select to print the document by using a printer driver of a host apparatus connected to the image forming apparatus.

According to an aspect of the present invention, the displaying of the message enabling the user to select whether to perform the direct printing operation includes displaying an option enabling the user to select to end the direct printing operation if it is determined that the direct printing standard is not satisfied.

According to an aspect of the present invention, the displaying of the message enabling the user to select whether to perform the direct printing operation further includes displaying another message indicating whether the document can be properly printed by the printer driver.

According to an aspect of the present invention, the image forming method further includes receiving a command from the user selecting to print the document by using the printer driver.

According to an aspect of the present invention, the method further includes determining whether the printer driver is installed in the host apparatus, and if not, transmitting a request to download the printer driver from an outside source to install the printer driver in the host apparatus.

According to an aspect of the present invention, the displaying of the message enabling the user to select whether to perform the direct printing operation further includes performing a preview function of an image to be formed by the image forming apparatus.

The foregoing and/or other aspects of the present invention are also achieved by providing an image forming apparatus, including a receiver which receives a direct printing command with respect to a document; an image forming unit which forms an image with respect to the document; and a controller which determines whether a direct printing standard, which is used to properly perform a direct printing operation with respect to the document, is satisfied, and which displays a message enabling a user to select whether to perform the direct printing operation with respect to the document if the direct printing standard is not satisfied.

According to an aspect of the present invention, the controller determines that the direct printing standard is not satisfied by determining that at least one of an interpreter, a filter and a font resource of the document is not provided in the image forming apparatus, or that version information of the document does not correspond to an image format version of the image forming apparatus.

According to an aspect of the present invention, the controller downloads whichever of the interpreter, the filter and the font resource are determined not to be provided in the image forming apparatus.

According to an aspect of the present invention, the controller updates the image format version of the image forming apparatus to print the document if the version information of the document does not correspond to the image format version of the image forming apparatus.

According to an aspect of the present invention, the controller enables the user to control the image forming unit to print the document by using a printer driver of a host apparatus connected to the image forming apparatus.

According to an aspect of the present invention, the controller enables the user to control the image forming unit to end the direct printing operation if the direct printing standard is not satisfied.

According to an aspect of the present invention, the controller displays another message indicating whether the document can be properly printed by the printer driver.

According to an aspect of the present invention, the image forming apparatus further includes a user input unit, wherein the controller receives a command through the user input unit to print the document by using the printer driver.

According to an aspect of the present invention, the controller determines whether the printer driver is installed in the host apparatus to form an image, and if not, transmits a request to download the printer driver from an outside source to install the printer driver in the host apparatus.

According to an aspect of the present invention, the controller performs a preview function of an image to be formed by the image forming apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image forming apparatus according to an embodiment of the present invention;

FIG. 2 is a block diagram of an image forming apparatus according to another embodiment of the present invention;

FIG. 3 illustrates a user interface of the image forming apparatus according to an embodiment of the present invention;

FIG. 4A illustrates a process of setting a printing standard directly from the image forming apparatus according to an embodiment of the present invention;

FIG. 4B illustrates a user interface which displays unsatisfied printing standards from the image forming apparatus according to an embodiment of the present invention; and

FIG. 5 is a flowchart to describe an image forming method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

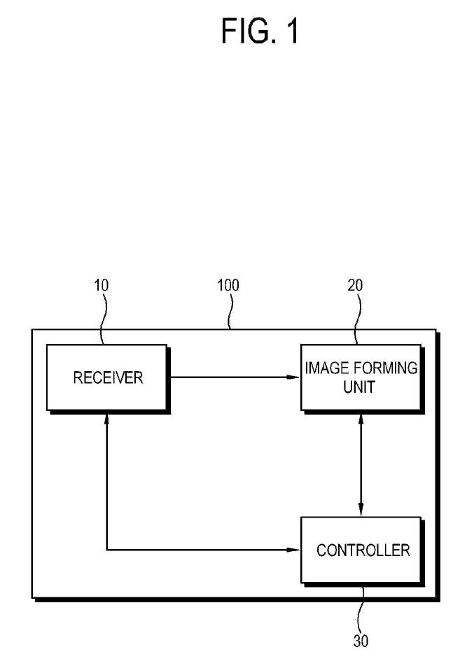

FIG. 1 is a block diagram of an image forming apparatus according to an embodiment of the present invention. As shown therein, an image forming apparatus 100 includes a receiver 10, an image forming unit 20 and a controller 30.

The receiver 10 receives a command to perform a direct printing operation with respect to a document. According to an aspect of the present invention, the receiver 10 receives printing data including a document. The receiver 10 may also receive printing data from an additional memory according to an interface standard such as a USB (universal serial port).

The image forming unit 20 forms an image with respect to the document. The image forming unit 20 includes a photosensitive body (not shown) to form an electrostatic latent image thereon, a developing unit (not shown) to develop the electrostatic latent image on the photosensitive body and a transfer unit (not shown) to transfer the developer from the photosensitive body to a printing medium, such as a sheet of paper, a transparency sheet, stationary, etc., and form an image on the printing medium. According to an aspect of the present invention, the image forming unit 20 includes a rendering module to perform a data rendering and print the document.

The image forming unit 20 may perform a direct printing operation with respect to image formats, such as, for example, JPEG files, TIFF files, text files and PDF (portable document format) files. According to an aspect of the present invention, the image forming unit 20 includes an interpreter, filter and font resources of PDF files to perform a direct printing operation with respect to PDF files. It is understood that the image forming unit 20 may additionally include other resources to perform direct printing operations with respect to the other types of files.

The controller 30 determines whether at least one printing standard is satisfied to print the document directly by the image forming unit 20. If the controller 30 determines that the printing standard is not satisfied, the controller 30 displays a message asking a user whether to perform the direct printing operation.

Particularly, if the PDF document is directly printed, the controller 30 determines whether the PDF interpreter and filter are provided in the image forming apparatus 100 to perform the direct printing operation. Also, the controller 30 may determine whether the PDF font resources are stored in the image forming apparatus 100 or whether the PDF document having a predetermined version is printable by the image forming unit 20 to thereby determine whether the direct printing standard is satisfied.

If the controller 30 determines that at least one of the PDF interpreter, the filter and the font resources has not been provided in the image forming apparatus 100, i.e., is not already stored in the image forming apparatus 100, the controller 30 may be controlled to download the at least one of the PDF interpreter, the filter and the font resources from an outside source to thereby perform the PDF direct printing operation. It is understood that “at least one” of the PDF interpreter, the filter and the font resources may refer to only one of these items, or any combination of two or more of these items.

According to an aspect of the present invention, if the controller 30 determines that the PDF document cannot be correctly processed due to the version information of the PDF document not corresponding to the PDF version stored in the image forming apparatus 100, the controller 30 automatically renews the PDF version of the image forming apparatus 100 to print the PDF document using the renewed PDF version information.

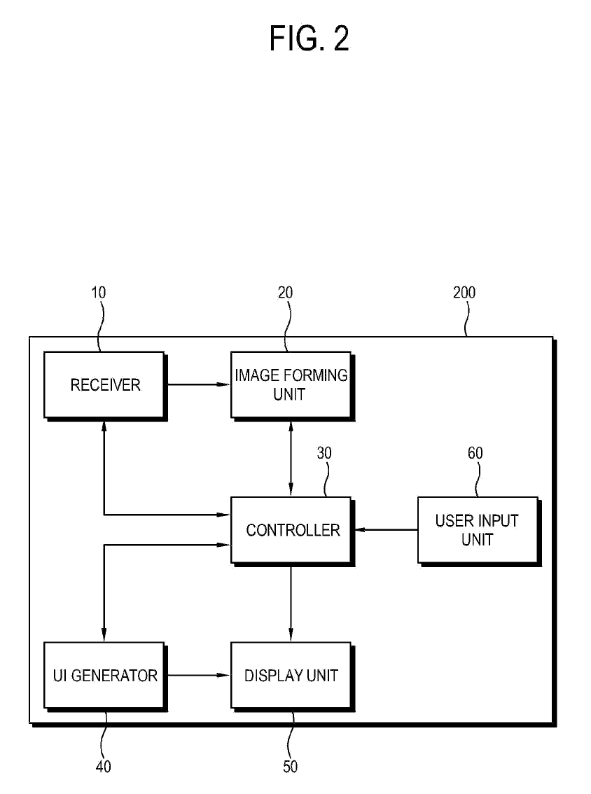

FIG. 2 is a block diagram of an image forming apparatus 200 according to another embodiment of the present invention. As shown therein, the image forming apparatus 200 includes the receiver 10, image forming unit 20 and controller 30 shown in FIG. 1 and further includes a user interface (UI) generator 40, a display unit 50 and a user input unit 60.

The UI generator 40 generates a UI to display a message to be read by a user, indicating that a direct printing standard is not satisfied, and thus that a direct printing operation may not accurately print the image, according to a determination made by the controller 30. The UI generator 40 may further generate a UI to directly set the printing standard, which will be described later.

If the controller 30 determines that the direct printing standard is not satisfied, the display unit 50 displays a message to a user asking whether to perform the direct printing operation. The image forming apparatus 200 may further output a predetermined audio signal indicating to a user that the direct printing standard is not satisfied and that the user should decide whether to perform the direct printing, instead of or in addition to visually displaying the UI. If the direct printing standard is not satisfied, the user input unit 60 enables a user to transmit a command to the image forming apparatus 200 to end the printing operation, to form an image by using a host apparatus, or to perform the direct printing operation regardless of the unsatisfied standard.

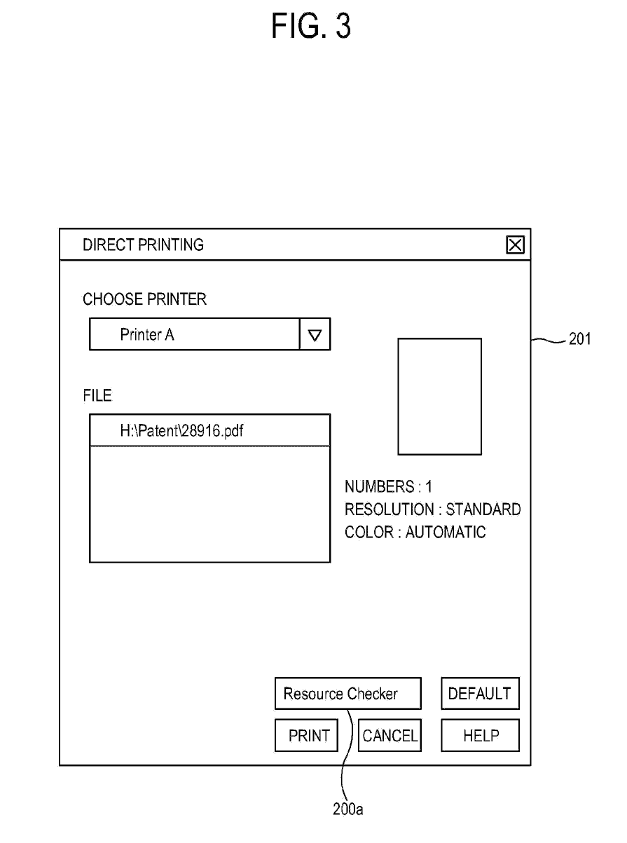

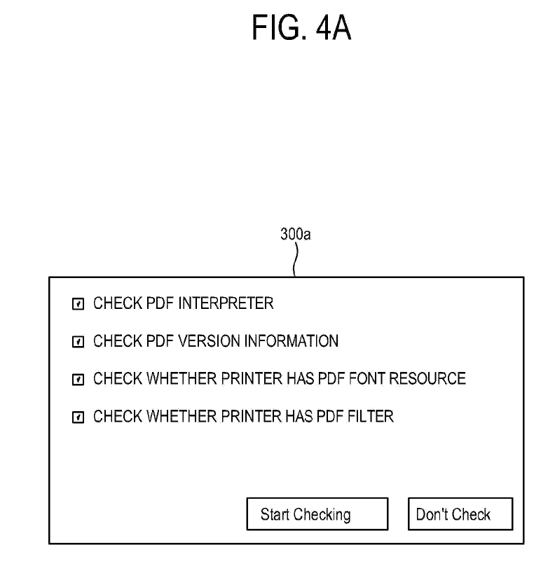

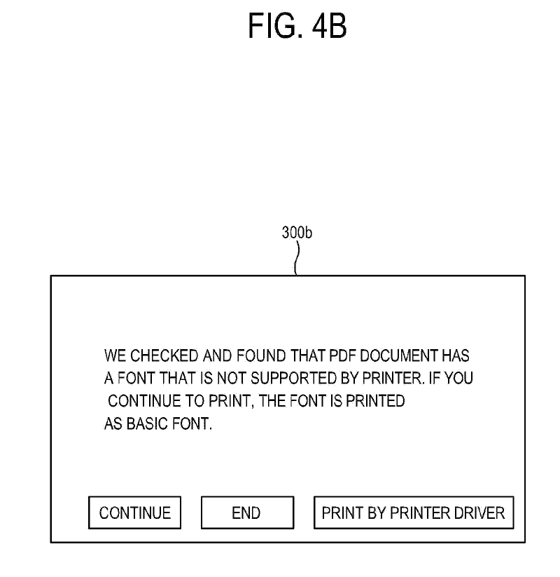

Hereinafter, an example of a user interface (UI) 201, which displays a message to enable a user to select whether to control the image forming apparatus 100 to perform the direct printing operation, will be described with reference to FIGS. 3, 4A and 4B. Although described with reference to the image forming apparatus 100 according to an embodiment of the present invention (FIG. 1), it is understood that the UI 201 may also be implemented with the image forming apparatus 200 (FIG. 2), or other image forming apparatuses not shown.

As shown in FIG. 3, the UI 300 according to an aspect of the present invention includes a resource checker button 200a which enables a user to directly set the printing standard. The UI 200 may be transmitted to the display unit 50 through an EWS (embedded web service) or may be included in a DPU (direct printing unit).

If a user presses the resource checker button 200a, a user interface 300a is displayed as shown in FIG. 4A. As shown therein, specific items of the direct printing standard include items such as whether the image forming apparatus 100 includes a PDF interpreter, PDF version information which enables the image forming unit 20 to accurately form an image with respect to a PDF version, a PDF font resource, and a PDF filter. A user may check or uncheck the items of the UI 300a to directly set the printing standard. It is understood that the printing standard may include various other items in addition to those shown in FIG. 4A.

FIG. 4B illustrates a user interface 300b which is displayed if the direct printing standard of the image forming apparatus 100 is not satisfied, i.e., if the controller 30 determines that at least one of the checked items in the user interface 300a is not available in the image forming apparatus 100. As shown therein, if the image forming apparatus 100 does not satisfy the direct printing standard, a user may continue to perform the printing operation, end the printing operation, or print the document with a printer driver.

According to an aspect of the present invention, if a user selects to continue to perform the direct printing operation, a preview function is performed to display a preview of a printing result to a user, and then the user selects whether to continue to perform the direct printing operation. It is understood that the preview function is not required to be performed. If a user selects to end the printing operation, the controller 30 controls the image forming unit 20 to end the image forming operation of the document.

If the user selects to perform the printing operation by using the printer driver, the controller 30 controls the image forming unit 20 to form an image with printing data processed by the host apparatus instead of performing the direct printing operation. If the controller 30 determines that a proper printer driver is not installed in the host apparatus, the controller 30 transmits a message to an external device, such as a server, to transmit the proper printer driver to the host apparatus so that the proper printer driver may be installed to form an image. If the image forming apparatus 100 does not satisfy the direct printing standard, the image forming apparatus 100 informs a user of this failure by transmitting a message, such as, for example, the UI 300b which is visually displayed, to warn the user that a direct printing operation may produce unsatisfactory results, thereby maintaining the image quality of an image and preventing unnecessary use of printing media and toner.

According to an aspect of the present invention, the user interfaces 201, 200a, 300a and 300b may be displayed on the image forming apparatus 100, the host apparatus, or on a combination thereof.

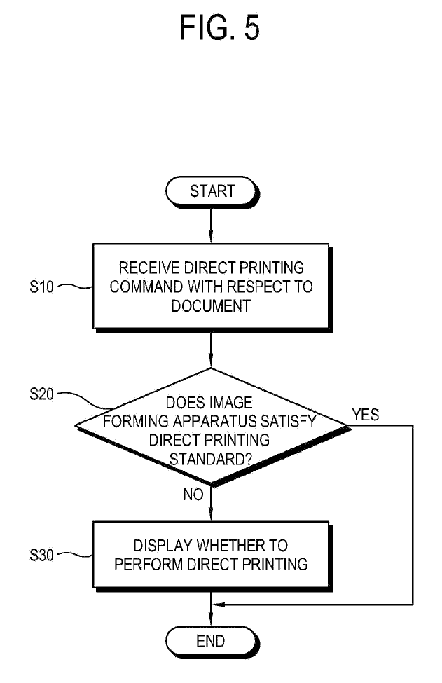

Hereinafter, an image forming method according to an embodiment of the present invention will be described with reference to FIG. 5. First, the receiver 10 receives a command to perform a direct printing operation with respect to a document at operation S10.

The controller 30 determines whether the image forming apparatus 100 satisfies the predetermined direct printing standard to perform the direct printing operation at operation S20. According to an aspect of the present invention, the direct printing standard may include items such as, for example, whether the image forming apparatus 100 includes the PDF interpreter, the PDF version information which enables the image forming unit 20 to form an image according to a corresponding PDF version, the PDF font resources, and the PDF filter.

If the controller 30 determines that the direct printing standard is not satisfied, the controller 30 displays a message to a user enabling the user to select whether to perform the direct printing operation with respect to the document at operation S30. Operation S30 may further include an operation of enabling a user to select whether to end the direct printing operation or to perform the printing operation by using the printer driver of the host apparatus. Furthermore, according to another aspect of the present invention, at operation S30, the availability of a proper printer driver to form the image may be displayed or otherwise communicated to a user.

The operation of performing the printing operation by the printer driver of the host apparatus may include an operation of determining whether the proper printer driver is installed in the host apparatus to form an image. If not, the operation of performing the printing operation may further include transmitting a request to an outside source, such as a server, the Internet, etc., requesting the proper printer driver to be downloaded from the outside source and installed to the host apparatus. It is understood that the operation of transmitting a request may be performed automatically by the controller 30, although is not limited thereto.

According to an aspect of the present invention, the operation S30 further includes an operation of performing a preview function of an image formed by the image forming apparatus 100. This preview function may be used if a user selects to perform a direct printing operation, or if a user selects to perform a printing operation using a printer driver in a host apparatus. It is understood that the preview function may be omitted.

If the direct printing standard is not satisfied, the image forming apparatus 100 informs a user of this information by transmitting a message to the user to prevent a user from performing a direct printing operation, thereby maintaining the image quality of an image and preventing the unnecessary use of printing media and toner.

As described above, an image forming method and an image forming apparatus 100 according to aspects of the present invention display a message to a user indicating that a direct printing standard is not satisfied, to maintain high quality of an image.

Also, the image forming method and the image forming apparatus 100 according to aspects of the present invention prevent an unnecessary use of printing media and toner when a user does not desire to perform a direct printing operation using an image forming apparatus 100 that does not satisfy a direct printing standard.

Further, the image forming method and the image forming apparatus 100 according to aspects of the present invention enable a user to use a host apparatus instead of the image forming apparatus 100 to form an image, if the image forming apparatus 100 does not satisfy a direct printing standard.

Further, the image forming method and the image forming apparatus 100 according to aspects of the present invention automatically install a proper printer driver in a host apparatus if the printer driver is not installed in a host apparatus.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. An image forming method to be used with an image forming apparatus, the image forming method comprising:
receiving a command to perform a direct printing operation with respect to a document;
determining whether a direct printing standard, which is used to properly perform the direct printing operation with respect to the document, is satisfied; and
displaying a message enabling a user to select whether to perform the direct printing operation if the direct printing standard is not satisfied.

2. The image forming method according to claim 1, wherein the determining of whether the direct printing standard is satisfied comprises determining whether at least one of a document interpreter, a filter and a font resource is provided in the image forming apparatus, or determining whether version information of the document corresponds to an image format version of the image forming apparatus.

3. The image forming method according to claim 2, further comprising downloading whichever of the at least one of the interpreter, the filter and the font resource are determined not to have been provided in the image forming apparatus.

4. The image forming method according to claim 2, further comprising updating the image format version of the image forming apparatus to print the document if the version information of the document does not correspond to the image format version of the image forming apparatus.

5. The image forming method according to claim 1, wherein the displaying of the message enabling the user to select whether to perform the direct printing operation comprises displaying an option enabling the user to select to print the document by using a printer driver of a host apparatus connected to the image forming apparatus.

6. The image forming method according to claim 1, wherein the displaying of the message enabling the user to select whether to perform the direct printing operation comprises displaying an option enabling the user to select to end the direct printing operation if the direct printing standard is not satisfied.

7. The image forming method according to claim 5, wherein the displaying of the message enabling the user to select whether to perform the direct printing operation further comprises displaying another message indicating whether the document can be properly printed by the printer driver.

8. The image forming method according to claim 5, further comprising receiving a command from the user selecting to print the document by using the printer driver.

9. The image forming method according to claim 5, further comprising determining whether the printer driver is installed in the host apparatus, and if not,
transmitting a request to download the printer driver from an outside source to install the printer driver in the host apparatus.

10. The image forming method according to claim 1, wherein the displaying of the message enabling the user to select whether to perform the direct printing operation further comprises performing a preview function of an image to be formed by the image forming apparatus.

11. An image forming apparatus, comprising:
a receiver which receives a direct printing command with respect to a document;
an image forming unit which forms an image with respect to the document; and
a controller which determines whether a direct printing standard, which is used to properly perform a direct printing operation with respect to the document, is satisfied, and which displays a message enabling a user to select whether to perform the direct printing operation with respect to the document if the direct printing standard is not satisfied.

12. The image forming apparatus according to claim 11, wherein the controller determines that the direct printing standard is not satisfied by determining that at least one of an interpreter, a filter and a font resource of the document has not been provided in the image forming apparatus, or that version information of the document does not correspond to an image format version of the image forming apparatus.

13. The image forming apparatus according to claim 12, wherein the controller downloads whichever of the interpreter, the filter and the font resource are determined not to have been provided in the image forming apparatus.

14. The image forming apparatus according to claim 12, wherein the controller updates the image format version of the image forming apparatus to print the document if the version information of the document does not correspond to the image format version of the image forming apparatus.

15. The image forming apparatus according to claim 11, wherein the controller enables the user to control the image forming unit to print the document by using a printer driver of a host apparatus connected to the image forming apparatus.

16. The image forming apparatus according to claim 11, wherein the controller enables the user to control the image forming unit to end the direct printing operation if the direct printing standard is not satisfied.

17. The image forming apparatus according to claim 15, wherein the controller displays another message indicating whether the document can be properly printed by the printer driver.

18. The image forming apparatus according to claim 15, further comprising a user input unit, wherein
the controller receives a command through the user input unit to print the document by using the printer driver.

19. The image forming apparatus according to claim 15, wherein the controller determines whether the printer driver is installed in the host apparatus to form an image, and if not, transmits a request to download the printer driver from an outside source to install the printer driver in the host apparatus.

20. The image forming apparatus according to claim 11, wherein the controller performs a preview function of an image to be formed by the image forming apparatus.

21. An image forming method to be used with an image forming apparatus, the image forming method comprising:
determining whether a direct printing standard, which enables the image forming apparatus to directly process image data of a document and directly perform a printing operation, is satisfied; and
if not, automatically downloading a printer driver from an outside source to install the printer driver in a host apparatus connected to the image forming apparatus to process the image data.

22. The image forming method according to claim 21, wherein the determining of whether the direct printing standard is satisfied comprises determining whether at least one of a document interpreter, a filter and a font resource is provided in the image forming apparatus, or determining whether version information of the document corresponds to an image format version of the image forming apparatus.

23. The image forming method according to claim 21, wherein the automatically downloading of the printer driver comprises automatically downloading the printer driver from a server connected to the image forming apparatus or the Internet.

24. The image forming method according to claim 22, further comprising generating a user interface which displays boxes corresponding to the document interpreter, the filter, the font resource and the version information, wherein the user sets the direct printing standard by checking at least one of the boxes.

25. An image forming apparatus, comprising:
an image forming unit which forms an image with respect to a document; and
a controller which determines whether a direct printing standard, which enables the image forming apparatus to directly process image data of the document and directly perform a printing operation, is satisfied, and if not, automatically downloads a printer driver from an outside source to be installed in a host apparatus connected to the image forming apparatus to process the image data.
